(19) United States
(12) Patent Application Publication
(10) Pub. No.: US 2024/0053527 A1
(43) Pub. Date: Feb. 15, 2024

(54) LIGHT GUIDE WITH OUTCOUPLING STRUCTURE

(71) Applicants: PLASTIC OMNIUM LIGHTING SYSTEMS GMBH, Munich (DE); REHAU Automotive SE & Co. KG, Rehau (DE)

(72) Inventors: Stephan Schwaiger, Herbrechtingen (DE); Oliver Woisetschläger, Sontheim an der Brenz (DE); Joachim Stöhr, Giengen / Brenz (DE); Jürgen Hager, Herbrechtingen (DE); Patrick Kätzel, Rehau (DE); Rick Göschel, Feilitzsch (DE); Johann Reichstein, Bayreuth (DE)

(73) Assignees: PLASTIC OMNIUM LIGHTING SYSTEMS GMBH, Munich (DE); REHAU Automotive SE & Co. KG, Rehau (DE)

(21) Appl. No.: 18/233,060

(22) Filed: Aug. 11, 2023

(30) Foreign Application Priority Data
Aug. 11, 2022 (DE) 102022120364.6

(51) Int. Cl. F21V 8/00; G01S 7/02

(52) U.S. Cl. CPC G02B 6/0036; G02B 6/0065; G01S 7/027

(57) ABSTRACT

A light guide comprising an outcoupling structure is provided. The outcoupling structure is adapted to deflect a light coupled into the light guide in a first predetermined outcoupling direction. The outcoupling structure is formed by a configuration of a surface of the light guide.

### CROSS-REFERENCE TO RELATED APPLICATIONS

This application claims priority to DE application Serial No. 10 2022 120 364.6 filed Aug. 11, 2022, the disclosure of which is hereby incorporated in its entirety by reference herein.

### TECHNICAL FIELD

Aspects disclosed herein relate to a light guide comprising an outcoupling structure, in particular an outcoupling structure for coupling out a light coupled into the light guide in a predetermined direction (here referred to as “outcoupling direction”).

### BACKGROUND

Outcoupling structures for coupling out a light coupled into a light guide from this light guide are known. Thus, DE 10 2015 016 719 A1 discloses a planar light guide (in the following called “planar light guide” for short) into which light is coupled laterally and is, through the outcoupling structures embedded in an outer layer of the light guide, scattered and coupled out. The scattering effect of the outcoupling structures during illumination is caused by “fillers” which are, however, despite their scattering effect, transparent for visible light when radiated therewith.

DE 10 2014 213 502 A1 entitled “Protective Element for a Radar Sensor in a Motor Vehicle” discloses protective elements. Such protective elements are, in a different dimension, also known from other fields, for instance, as enclosures of radar units for protection against weather influences in the form of radar domes, so-called radomes, wherein a preferably high transparency for the electromagnetic radiation used for this purpose in the radio frequency range from e.g., 76.5-81 GHz (in the following “radar waves” for short) is aimed for. In DE 10 2014 213 502 A1 the radar sensor is arranged in a housing which is covered by a protective layer. The thickness of the protective layer is, however, with respect to its damping, a compromise between situations in which an ice layer has formed on the protective element, which also has a damping effect, and situations in which such further layer has not formed. It is, moreover, basically a disadvantage with such a construction that any further layer increases the damping for radar waves and constitutes an additional, expensive process step.

Outcoupling structures such as the ones described by way of example above may indeed be generated in the transforming process of a planar light guide but are as a rule—as also noted in DE 10 2015 016 719 A1—optimized with respect to the outcoupling of light and disturb the radar waves due to reflection and deflection.

It is to be noted that light is here understood to be the part of the electromagnetic spectrum which is visible for the human eye, and a light guide is understood to be an optical component adapted to guide light by total reflection at an interface layer between an inner part (or core in the case of a glass fiber, for instance) and an outer part (or sheath in the case of a glass fiber) of the light guide, wherein the outer part has a lower index of refraction (e.g. in the case of air n˜1). Accordingly, it may be useful to differentiate between “light-optical” (electromagnetic radiation in the range from approx. 380 nm to 780 nm) and “radar-optical” (electromagnetic radiation in the range from approx. 1 mm to 1 m, especially for the above-mentioned radar frequencies in the range from 1 mm to 10 mm).

### SUMMARY

In one object, the embodiments disclosed herein generally provide a light guide comprising an outcoupling structure which is optimized both pursuant to optical aspects and with respect to radar waves, e.g., comprising an outcoupling structure whose damping of radar waves, for instance, by absorption or reflection, is minimized, a radar device comprising such a light guide, and a method for manufacturing such a light guide.

This object may be solved by, among other things, the claimed invention. Additional and advantageous embodiments are also defined herein.

In accordance with another embodiment, a light guide is provided that includes an outcoupling structure adapted to deflect light coupled into the light guide in a predetermined outcoupling direction. The light guide in that the outcoupling structure is formed by a configuration of a surface of the light guide.

“Configuration of a surface” here designates substantially well-defined geometric or shape-free structural elements arranged in a well-defined or random manner and having a particular shape and size, which characterize a difference over an unstructured, plane surface without such structural elements, and are referred to as outcoupling structure in their entirety, and are adapted to maximize the transparency, more exactly the degree of transmission, of the light guide for radar waves and to minimize losses in advance by reflection. Specifically, in accordance with the present invention, the outcoupling structure does not consist of an additional optical layer applied onto the light guide, whose manufacturing would, as already mentioned above, be expensive and whose optimal thickness would depend on external factors.

In accordance with an advantageous embodiment, the light guide is formed as a planar light guide comprising a first main surface and a second main surface opposite to the first main surface, wherein the first and second main surfaces extend perpendicular to a direction of a thickness d of the light guide and the outcoupling structure is formed in the first main surface.

In accordance with an embodiment, the light guide thus has substantially the shape of a plane-parallel plate with a thickness d as the distance between its first and its second main surfaces and lateral surfaces which connect the first and second main surfaces with each other, wherein preferably the second main surface is plane and unstructured and the first outcoupling structure is formed only in the first main surface. Alternatively, the outcoupling structure may be formed in the first main surface and additionally in the second main surface. Alternatively, instead of plane-parallel, the light guide might also be “only” parallel, e.g., be formed of two parallel, but curved planes.

In accordance with another embodiment, the first main surface comprises an outcoupling area in which the outcoupling structure is formed, and a non-outcoupling area in which the outcoupling structure is not formed.

In accordance with an embodiment, the outcoupling structure may extend (a) across the entire first main surface, or (b) only over a part of the first main surface. In case (b), at least the area of the second main surface which is opposite to the complementary non-outcoupling area of the first main surface is plane and unstructured.

In accordance with another embodiment, the outcoupling area comprises a plurality of outcoupling portions which are not connected with each other.

Preferably, an outcoupling area is, as already mentioned above, characterized by its parameters size, shape, and number (density) of its elements. The first main surface may comprise a coherent outcoupling area or—as in this advantageous embodiment—an outcoupling area subdivided into a plurality of outcoupling portions A, B, C . . . , wherein the parameters of the individual outcoupling portions A, B, C . . . may be equal or different. In a corresponding cross-section of the light guide an arrangement B-N-C-N-A-N-A-N-B . . . may thus exist, wherein N is part of the non-outcoupling area. Alternatively or additionally, the parameters may also vary within an outcoupling portion.

In accordance with another embodiment, the outcoupling area has a first thickness d1 and the non-outcoupling area has a second thickness d2, wherein the thicknesses d1 and d2 each are the distance between the first main surface and the second main surface and d1≠d2.

Since in the outcoupling area the first main surface possesses a configuration deviating from an unstructured surface, through which the desired radar-optical and light-optical characteristics may be achieved, the outcoupling area possesses other dielectric characteristics than the non-outcoupling area. The first main surface in the outcoupling area may, therefore, also be designated as light guide material-air-mixed surface or—in analogy to foamed plastics which comprise gas inclusions—as “foam”. The above-mentioned thickness d is, therefore, not defined uniformly across the entire light guide, but area by area, wherein the individual areas of the first main surface merge preferably gradually, alternatively stepwise, and a thickness d1 which is equivalent to the optimal thickness d2 depends on the size, shape, and number (density) of the elements which characterize the property of the first main surface in the outcoupling area and will be referred to as its parameters in the following. Whether d1>d2 or d1<d2 depends on whether the individual elements (in the following also called “structural elements”) are elevated relative to the first main surface, e.g., project (d1>d2), or form recesses (d1<d2). If, for instance, the outcoupling area occupies approximately 5% of the entire first main surface and d2=3.5 mm, the difference d1−d2 is approx. 100 μm.

The height (or else the depth) of the outcoupling structures is inter alia defined by the optical characteristics (visible area!). The thickness of the light guide (d2 in the area without outcoupling structures and d1 in the area with outcoupling structures) is chosen exclusively under radar-technical aspects, namely such that the thickness of the light guide ranges in or close to a minimum of the radar damping. This is generally the case if the (radar-optical!) path length of the radar radiation corresponds to a multiple of half the wavelength of the radar radiation in the material. For d2 and/or areas without outcoupling structures this may be calculated directly by via the radar frequency and the refraction number (and/or the electric permittivity). For d1 and areas with outcoupling structures (“foam”) this is achieved in that—simplified—the geometric mean of the permittivity values is used for calculating.

Example: If a light guide has a permittivity (formerly relative permittivity) εᵣ of 2.77 (the permittivity of air is approx. 1) and if the volume share of air in the area of the outcoupling structures calculated across the entire thickness of the light guide is 5%, the permittivity in the area of the “foam” (e.g., in the area of the outcoupling structures) is approx. 2.638 averaged, which entails an optimal layer thickness d1 in this area of 3.619 mm. In comparison with this, the optimal layer thickness d2 in the area without outcoupling structures is 3.532 mm.

This entails that the layer thickness in the area without outcoupling structures is only 87 μm smaller although the outcoupling structures have a depth of 500 μm.

The thicknesses may be calculated, on the one hand. On the other hand, they may be simulated by way of raytracing with any effects conceivable, be measured on prototypes, and be optimized thereupon.

In accordance with another embodiment, the outcoupling structure comprises structural elements arranged in the manner of a two-dimensional Bravais lattice at the lattice points thereof in the first main surface.

In a k-dimensional Bravais lattice, k “primitive” vectors a, b, c . . . span a k-dimensional lattice, namely such that for k=2 the individual lattice points are at the (vector) points R=n·a+m·b with n, m∈ [symbol] . The natural numbers n, m may be identical across the entire outcoupling area or outcoupling portion, whereby it is strictly regular. Or, they may each change in a defined or arbitrary manner in at least one direction parallel to the respective outcoupling area or outcoupling portion, e.g. increase both in the direction a and in the direction b, so that in this example the structure stretches in the direction R.

In a top view of the first main surface, the structural elements may be rotationally symmetric or not rotationally symmetric or free-form. Structural elements which are rotationally symmetric in top view may be polyhedrons with z-fold symmetry, straight circular cones or truncated cones or segments of balls or ellipsoids. Furthermore, the structural elements may have arbitrarily irregular, unsymmetric, or mathematically non-defined shapes.

It is also possible to provide the structural elements with a ball scraper as a hood (transitions abrupt or faced). All these structures may be constructed to project into the material with perpendicular walls or conically tapering walls. Pyramid or prism-like structures may also be used.

In accordance with another embodiment, the size of the structural elements is constant or changes in a defined manner in at least one predetermined direction parallel to the first main surface.

“In at least one predetermined direction” entails that the size may change just like the position of the lattice points, e.g., determined by a vector which is a linear combination of a and b. The size may also be constant in one direction and variable in a further direction. “changes in a defined manner” entails that the size changes pursuant to particular specifications.

In accordance with another embodiment, at least one of the plurality of outcoupling portions comprises a plurality of outcoupling zones with a differently formed outcoupling structure.

In accordance with another embodiment, the individual formation portions may have different parameters, as already described above. Furthermore, the parameters may change differently within the individual formation portions.

In accordance with another embodiment, the structural elements each have a height d3 or a depth d4 relative to the first main surface.

This entails that the height(s) and the depth(s) are each measured with respect to the first main surface of the respective outcoupling portion in which they are positioned, and the structural elements may, as already mentioned above, be elevated or recessed, or some may be elevated, and some may be recessed.

In accordance with another embodiment, the light guide is formed of a plastic.

In accordance with another embodiment, the plastic is SMMA, PMMA, PC, PA12, PP, PU, or PET.

SMMA, PMMA, PC, PA12, PP, PU, or PET entails: Styrol Methyl Methacrylate, Polymethyl Methacrylate, Polycarbonate, Polyamide 12, Polypropylene Polyurethane and/or Polyethylene Terephthalate. This list is only exemplary, though. This indicates that any other suitable plastic may be used which possesses the required optical and possibly further characteristics.

In accordance with another embodiment, a radar device comprises the above-mentioned light guide and a radar sensor for emitting the radar waves, wherein the first main surface faces toward the radar sensor. Alternatively, the inverse case is also conceivable in which the outcoupling structures are formed at the side facing away.

In accordance with another embodiment, the radar device further comprises a cover, wherein the second main surface faces toward the cover.

In accordance with another embodiment the cover is part of the radar device. Alternatively, however, the cover may be formed by an external component which does not belong to the radar device, such as a faceplate component, so that the “complete radar device” consisting e.g., of a radar sensor for emitting and receiving radar waves, the above-defined planar light guide, and the cover only results by the installation, for instance, in a vehicle.

In accordance with another embodiment, the cover may serve as the light guide. This entails that the functions of both components are taken over by one single component. In this case, for instance, the above-mentioned faceplate component may also be designed as the light guide and comprise the above-mentioned structures (e.g., on the inner side), and be adapted appropriately in thickness.

In accordance with another embodiment, a method for manufacturing the above-mentioned light guide comprises an injection molding method, a lithography method, or a galvanic method.

### BRIEF DESCRIPTION OF THE DRAWINGS

In the following, advantageous embodiments of the present invention are described with reference to the enclosed drawings.

FIG. 1 is a section of a light guide in accordance with a first embodiment in a plane comprising a thickness direction of the light guide;

FIG. 2A is a section of a light guide in accordance with a second embodiment in a plane comprising a thickness direction of the light guide;

FIG. 2B is a modification of the second embodiment illustrated in FIG. 2A;

FIG. 3A is a radar device with the light guide illustrated in FIG. 2A;

FIG. 3B is a radar device with the light guide illustrated in FIG. 2B;

FIG. 4 shows a Table of exemplary parameters of the outcoupling structure and/or the structural elements.

### DETAILED DESCRIPTION

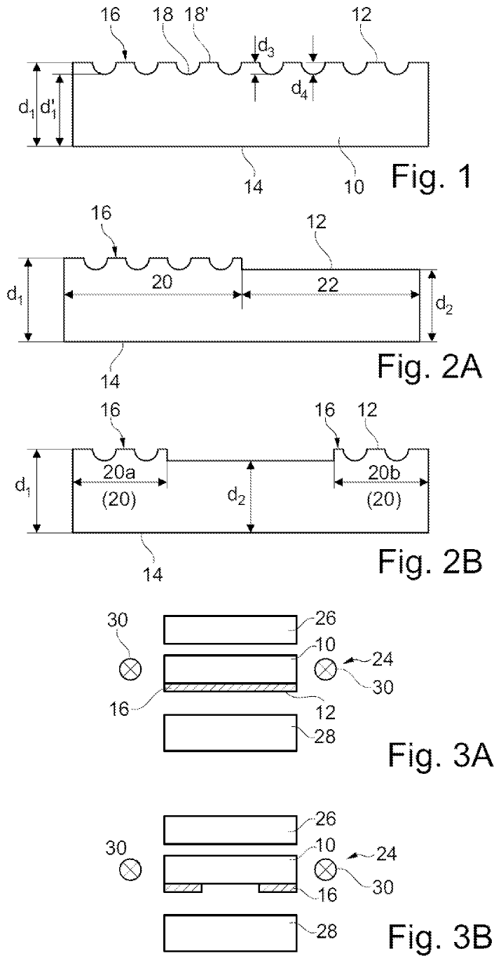

In accordance with a first embodiment illustrated in FIG. 1, a light guide 10 in accordance with a first embodiment comprises a thickness d1, a first main surface 12 (illustrated in bold print in the Figures), and a second main surface 14 (illustrated in bold print in the Figures). The first main surface 12 is formed as an outcoupling structure 16 which comprises regularly arranged structural elements 18 which are each formed as, in section, circular recesses with a depth d4 relative to the first main surface 12. Alternatively, which will not be pursued in the following, with the given dense arrangement, a thickness d1′ of the light guide 10 with d1′<d1 may also be assumed, so that structural elements 18′ which are positioned between the, in section, circular depressions 18 of the previous interpretation of FIG. 1, project relative to a first main surface 12 by a height d3, wherein there applies d3=d4. If the structural elements 18 are rotationally symmetric in the top view of the first main surface 12 (which cannot be recognized in section), the first interpretation is more meaningful. If, however, the structural elements 18′ are rotationally symmetric in the top view of the first main surface 12, the second interpretation is more meaningful. As already mentioned above, the height d3 and the depth d4 of the structural elements 18 are each indicated here with respect to the first main surface 12.

In accordance with a second embodiment illustrated in FIG. 2A, the first main surface 12 comprises an outcoupling area 20 in which the outcoupling structure 16 is formed, and a non-outcoupling area 22 in which the outcoupling structure is not formed. Specifically, the first main surface 12 comprises only one, namely coherent, outcoupling area 20. The modification of the second embodiment illustrated in FIG. 2B differs from this only in that the outcoupling area 20 is divided into a first outcoupling portion 20a and a second outcoupling portion 20b such that both portions 20a, 20b are disjunct and separated by the non-outcoupling portion 22 arranged therebetween.

As is shown in FIGS. 1, 2A, and 2B, the outcoupling structure 16 comprises in all cases the same structural elements 18 and the same parameters, such as kind of the structural element 18, size of the structural element 18, density of the elements 18 in the respective outcoupling area 20.

FIG. 3A shows schematically a radar device 24 comprising a faceplate component 26, a radar sensor 28, and the light guide 10 illustrated in FIG. 1 which is arranged between the faceplate component 26 and the radar sensor 28. It is to be noted that in FIG. 3A the position of the outcoupling structure 16, which is illustrated schematically in FIG. 2A, is shown in its correct position, e.g., facing toward the radar sensor 28. As is shown in FIG. 3A, the outcoupling structure 16 occupies the entire first main surface 12. As is shown schematically in FIG. 3A, light from the light sources 30 is coupled laterally into the light guide 10, deflected by the outcoupling structure 16 in the direction of the faceplate component 26, and coupled out two-dimensionally, wherein ideally the outcoupled light beams and the outcoupled radar waves are parallel to each other. It is to be noted that ideally both the light sources 30 and also any borders are positioned externally of the radar emission cone. In this case, the radar sensor 28 in the schematic illustration of FIG. 3A would be narrower.

FIG. 3B shows the radar device 24 with the faceplate component 26, the radar sensor 28, and the light guide 10 shown in FIG. 2B which is arranged between the faceplate component 26 and the radar sensor 28. The only difference to the radar device 24 shown in FIG. 3A is that of the outcoupling structure 16 being split.

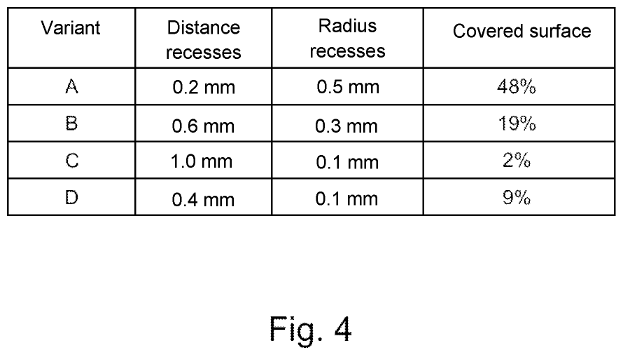

FIG. 4 shows a Table of exemplary parameters, e.g., the center distance of structural elements which are each formed as recesses, their radius as well as density, e.g., the “degree of coverage” of the first main surface with these structural elements.

### LIST OF REFERENCE NUMBERS

10 light guide
12 first main surface
14 second main surface
16 outcoupling structure
18, 18′ structural elements
20 outcoupling area
20a first outcoupling portion
20b second outcoupling portion
22 non-outcoupling portion
24 radar device
26 faceplate component
28 radar sensor
30 light sources
d1, d1′, d2 thicknesses
d3 height
d4 depth

What is claimed is:

1. A light guide comprising:
an outcoupling structure adapted to deflect light coupled into the light guide in a first predetermined outcoupling direction,
wherein the outcoupling structure is formed by a configuration of a surface of the light guide.

2. The light guide of claim 1, wherein the light guide is formed as a planar light guide comprising a first main surface and a second main surface opposite to the first main surface, wherein the first and second main surfaces extend perpendicular to a direction of a thickness d of the light guide and the outcoupling structure is formed in the first main surface.

3. The light guide of claim 2, wherein the first main surface comprises an outcoupling area in which the outcoupling structure is formed, and a non-outcoupling area in which the outcoupling structure is not formed.

4. The light guide of claim 3, wherein the outcoupling area comprises a plurality of outcoupling portions which are not connected with one another.

5. The light guide of claim 3, wherein the outcoupling area has a first thickness d1 and the non-outcoupling area has a second thickness d2, wherein the first and second thicknesses d1 and d2 each have a distance between the first main surface and the second main surface, and wherein the first thickness d1 is not equal to the second thickness d2.

6. The light guide of claim 2, wherein the outcoupling structure includes structural elements arranged in a two-dimensional Bravais lattice at lattice points thereof in the first main surface.

7. The light guide of claim 6, wherein a size of the structural elements is constant or changes in a defined manner in at least one predetermined direction parallel to the first main surface.

8. The light guide according of claim 6, characterized in that the structural elements each have a height d3 or a depth d4 relative to the first main surface.

9. The light guide of claim 1, further comprising at least one of a plurality of outcoupling portions including a plurality of outcoupling zones with a differently formed outcoupling structure.

10. The light guide of claim 1, wherein the light guide is formed of plastic.

11. The light guide according to claim 10, characterized in that the plastic is one of Styrol Methyl Methacrylate (SMMA), Polymethyl Methacrylate (PMMA), Polycarbonate (PC), Polyamide 12 (PA12), Polypropylene (PP), and Polyethylene Terephthalate. (PET).

12. A method of manufacturing the light guide of claim 1 via one of an injection molding method, a lithography method, or a galvanic method.

13. A radar device comprising:
a light guide including:
an outcoupling structure adapted to deflect light coupled into the light guide in a first predetermined outcoupling direction,
wherein the outcoupling structure is formed by a configuration of a surface of the light guide.

14. The radar device of claim 13, wherein the light guide is formed as a planar light guide comprising a first main surface and a second main surface opposite to the first main surface, wherein the first and second main surfaces extend perpendicular to a direction of a thickness d of the light guide and the outcoupling structure is formed in the first main surface.

15. The radar device of claim 14, wherein the first main surface comprises an outcoupling area in which the outcoupling structure is formed, and a non-outcoupling area in which the outcoupling structure is not formed.

16. The radar device of claim 15, wherein the outcoupling area comprises a plurality of outcoupling portions which are not connected with one another.

17. The radar device of claim 14, wherein the radar sensor emits radar waves, and wherein the first main surface faces toward the radar sensor.

18. The radar device of claim 14 further comprises a cover, wherein the second main surface faces toward the cover.

19. The radar device of claim 18, wherein the cover serves as the light guide.

20. The radar device of claim 13, wherein the light guide is formed of plastic.
